(19) United States
(12) Patent Application Publication
(10) Pub. No.: US 2003/0046187 A1
(43) Pub. Date: Mar. 6, 2003

(54) Real estate marketing method having assisting images

(76) Inventor: Shih-I Yu, Chong Ho City (TW)

Correspondence Address: Shih-I Yu, P.O. Box 10-69, Chong Ho, Taipe, 235, TW

(21) Appl. No.: 09/883,605

(22) Filed: Jun. 16, 2001

(51) Int. Cl. G06F 17/60

(52) U.S. Cl. 705/27

(57) ABSTRACT

A method for marketing real estate includes classifying the real estate for sale, photoing the real estate for sale, and establishing a data base with the photos of the real estate for sale for searching purposes. The buyers may obtain the required information or photos or recorded tapes via the internet system and with the personal computer, without going out to see every interesting buildings or houses. The maps or the quotations or the nearby streets around the real estate for sale may further be photoed or tape recorded or supplied in the internet system.

### BACKGROUND OF THE INVENTION

1. Field of the Invention

The present invention relates to a method, and more particularly to a method for marketing or selling or advertising the real estate.

2. Description of the Prior Art

Typically, the estate agents or the house owners may market their real estate in the newspapers, or in the other advertisements. The requesters or the real estate purchasers or the buyers should read many of the newspapers, or the advertisements, and then should call the estate agents or the house owners in order to obtain the information for the houses for sale. After reading many and many newspapers, or the advertisements, the requesters or the real estate purchasers or the buyers may probably found almost none or few houses that they like. When the requesters or the real estate purchasers or the buyers have found a house that they like, they then should call the estate agents or the house owners again and should go to see and check the house personally, in order to realize the information or the conditions of the houses for sale. The requesters or the real estate purchasers or the buyers may spend a lot of time for searching the real estate.

The present invention has arisen to mitigate and/or obviate the afore-described disadvantages of the conventional methods for marketing or selling or advertising the real estate.

### SUMMARY OF THE INVENTION

The primary objective of the present invention is to provide a method for marketing or selling or advertising the real estate with assisting images and for allowing the requesters or the real estate purchasers or the buyers to get or obtain all the required information or condition of the houses for sale with the computer, or via the internet system.

In accordance with one aspect of the invention, there is provided a method for marketing real estate, the method comprising classifying real estate for sale, photoing the real estate for sale, and establishing a data base with the photos of the real estate for sale for searching purposes. The purchasers or the buyers may search and obtain the required information or photos or recorded tapes via the internet system and with the personal computer, without going out to see every interesting buildings or houses.

The nearby streets around the real estate for sale may further be photoed and stored or established or supplied in the internet system, such that the buyers may further easily realize the areas around the real estate for sale.

The real estate for sale may further be tape recorded and stored or established or supplied in the internet system.

The nearby streets around the real estate for sale may further be tape recorded and stored or established or supplied in the internet system.

The quotations and information of the real estate for sale may further be prepared or stored or established or supplied in the internet system.

The map in the area around the real estate and the nearby streets around the real estate for sale may further be stored or established or supplied in the internet system.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram illustrating the real estate marketing method in accordance with the present invention;

FIG. 2 is a block diagram illustrating the searching processes of real estate marketing method for the requesters;

FIG. 3 is a flow chart illustrating the detail processes of the real estate marketing method; and

FIG. 4 is a flow chart illustrating the other detail processes of the real estate marketing method for marketing different real estate.

### DETAILED DESCRIPTION OF THE PREFERRED EMBODIMENT

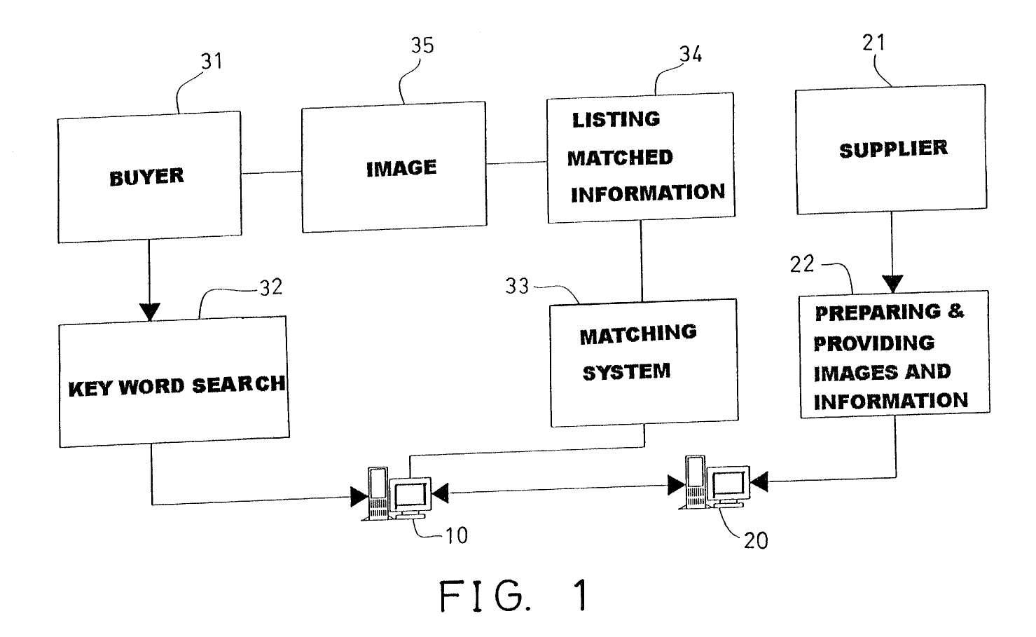

Referring to the drawings, and initially to FIG. 1, a method in accordance with the present invention is provided for communicating or matching the requirements between the real estate suppliers 21 (indicated by suppliers hereinafter) and the requesters or the real estate purchasers or the buyers 31 (indicated by buyers hereinafter). For example, the suppliers 21 may prepare or provide 22 the images and/or the information of the real estate for sale, and may store or establish a data base in a computer 20. For example, the suppliers 21 may take the photos with the digital cameras and/or may take the tapes with the digital video cameras, and may then establish or set up or store the images in a memory or in a hyper text markup language (abbreviated as HTML hereinafter) of the computer 20, for the internet system. The buyers 31 may search 32 with key words via the internet system and/or via a servo system 10 or the like. A matching system 33 in the servo system 10 may match the requirements of the buyers 31 and may list or show the matched information and/or images 35 to the buyers, such as to the computer of the buyers 31, such that the buyers 31 may get or obtain all the required information and images of the houses for sale.

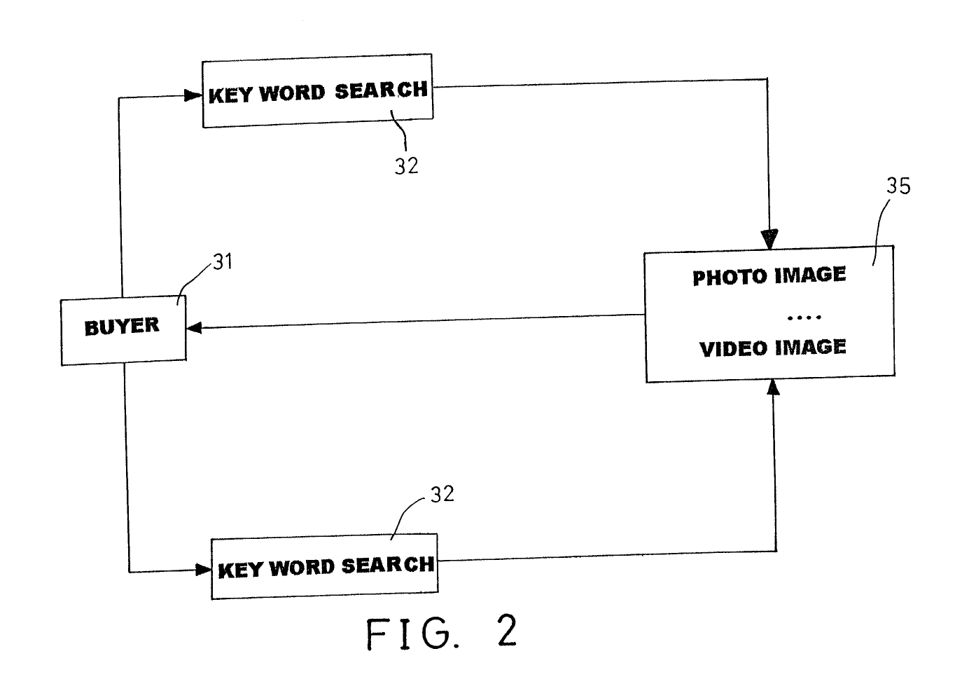

Referring next to FIG. 2, for example, the buyers 31 may search with various kinds of key words 32, such as the designated auction number, the street or the street number of the house, etc. The matched information and/or photo or video tape images 35 may then be sent back to the computer of the buyers 31, such that the buyers 31 may get or obtain all the required information and images of the houses for sale at home with the computer and the internet system, without going to see every interesting buildings or houses.

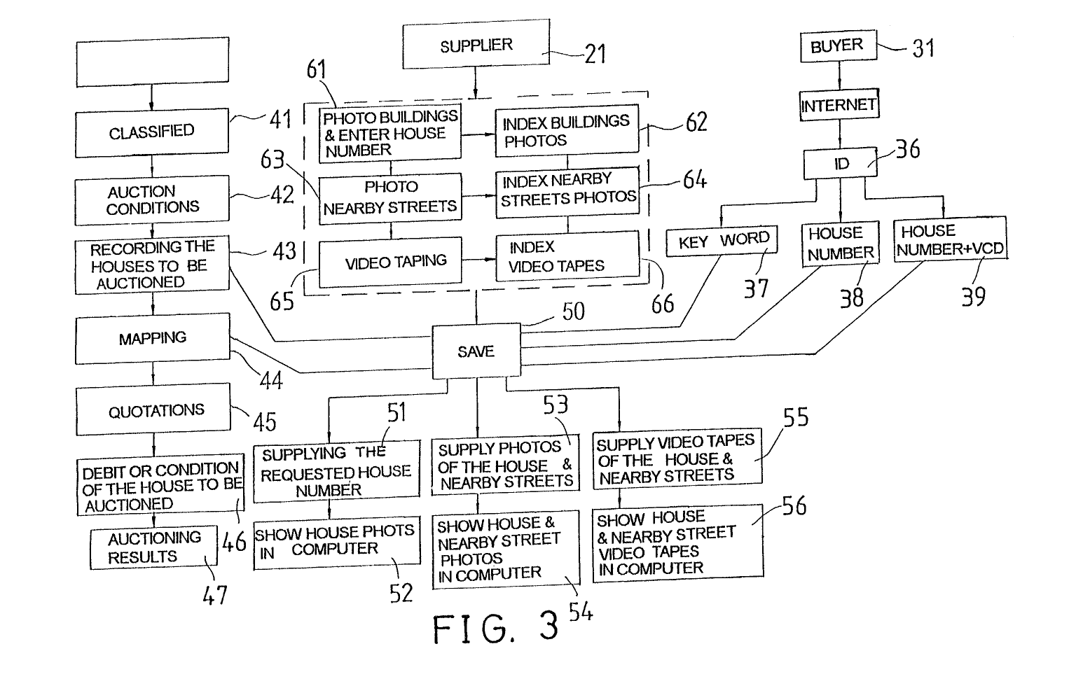

Referring next to FIG. 3, illustrated is the detail processes of the real estate marketing method for marketing the houses to be auctioned. As shown in the left portion of FIG. 3, for example, the houses or the buildings to be auctioned are classified 41, with such as the house sizes, the prices, and the areas of the houses to be auctioned. The auction conditions 42 of the house may be obtained from such as the court, and entered into the data base of the computer by the suppliers. The suppliers may then photo or tape record the houses to be auctioned, and may then establish or store or save 50 the images and/or information of the houses to be auctioned in the computer, such as in the HTML of the computer, for allowing the buyers to easily obtain the required images of the houses to be auctioned.

For example, as shown in the middle portion of FIG. 3, the suppliers 21 may photo, with such as the digital cameras, the building or the house and may enter the house number of the house to be auctioned 61, and may then index 62 the house or the building photos or images; and/or may photo the nearby streets of the house 63 and may then index 64 the nearby street photos 64; and/or may tape record 65, with the digital video cameras, the building or the house and/or the house number of the house to be auctioned and/or the nearby streets, and may then index 66 the video tapes. The images of the photos and/or of the video tapes may then be established or stored or saved 50 in the computer, such as in the HTML of the computer.

The suppliers 21 may also map 44 and store or establish the streets close to or around the houses to be auctioned in the HTML of the computer, and/or may prepare or obtain or supply the quotations 45 of the houses in the HTML of the computer, and/or may prepare or obtain or supply the debits or conditions of the houses 46 in the computer, and/or may obtain and supply the auctioning results right away to the computer or to the internet system.

The buyers 31 may enter into the internet system by entering their identification 36 or the like, and may then search by entering the required key words 37 and/or by entering the house numbers 38, and/or by entering the house numbers and the video compact discs 39, or the like. When the required or searched key words and/or house numbers have been matched or found, the requested house numbers may be shown 51 in such as the computer of the buyers 31, and then the images of the photos or of the video tapes may be shown 52 in the computer of the buyers 31. The images of the photos of the nearby streets may be selectively supplied 53 and shown 54 in the computer of the buyers 31. The images of the video tapes of the nearby streets may be selectively supplied 55 and shown 56 in the computer of the buyers 31. The buyers 31 may thus obtain all the required information and images of the houses for sale at home without going out to see every interesting buildings or houses.

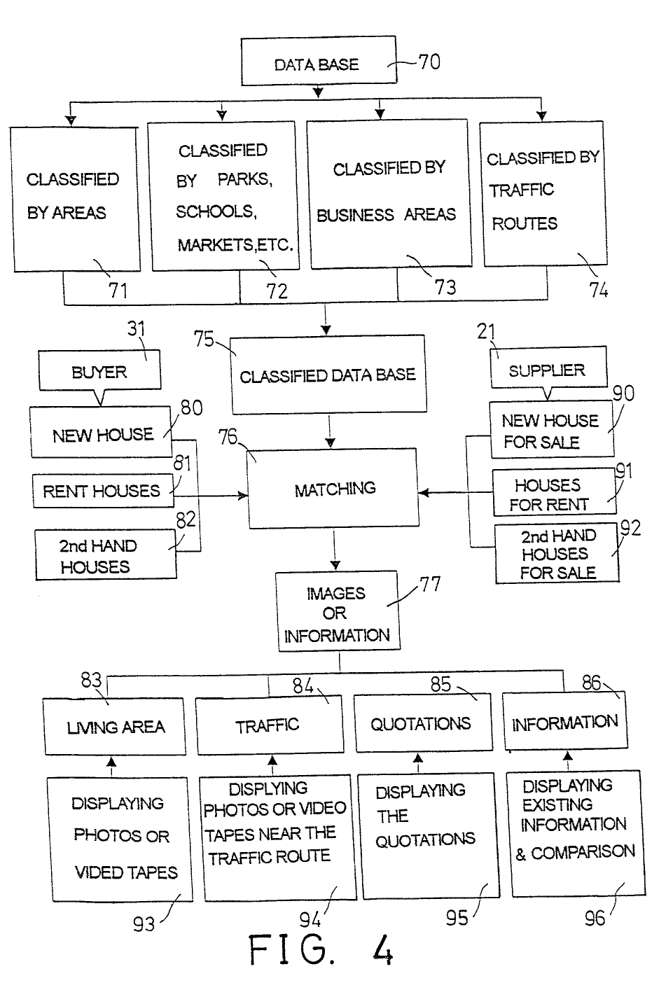

Referring next to FIG. 4, illustrated is the detail processes of the real estate marketing method for marketing the houses by the estate agents. First of all, the estate agents may establish the data base 70 which may be classified 71 by the areas, such as the mid-west area, east area, south area, etc., or classified 72 by the parks or schools or markets, etc., or classified 73 by the business areas, or classified 74 by traffic routes. The classified data base 75 may then be stored or saved or established in the HTML for further searching or matching 76 processes.

The suppliers 21 may then photo or tape record the new houses for sale 90, the houses for rent 91, the second houses for sale 92, and may supply the images and/or information of the houses for sale in the HTML of the computer, for allowing the buyers to easily obtain the required images of the houses to be auctioned. The buyers 31 may enter the key words or the requirements, such as the new houses for sale 80, the houses for rent 81, the second hand houses for sale 82, via the internet system or the like, in order to find the required houses.

When the required or searched key words and/or house numbers or the other requirements have been matched or found, the requested images or the information of the house numbers or houses or the other requirements 77 may be supplied to the buyers. For example, the photos or the video tapes or the images of the houses in the selected living area 83 may be shown or displayed 93 in the buyers' computers. Alternatively, the information or the photos or the video tapes or the images of the houses in or along or around the selected traffic route 84 may be shown or displayed 94 in the buyers' computers. Further alternatively, the quotations 85 of the selected houses may be shown or displayed 95 in the buyers' computers. Still further alternatively, the information 86 of the selected houses may be shown or displayed 96 in the buyers' computers. The suppliers may also provide the comparison of the quotations or information around the houses for sale.

In operation, the requesters or the buyers may obtain the information or the photos or the video tapes of the houses for sale or for auction in the selected living area or around the selected parks or around the selected schools or around the selected markets or along the selected traffic route, etc., by the internet system and by the computer, without going out to see every interesting houses or buildings.

Accordingly, the method in accordance with the present invention may be used for marketing or selling or advertising the real estate and for allowing the requesters or the real estate purchasers or the buyers to get or obtain all the required information or condition of the houses for sale with the computer, or via the internet system.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for marketing real estate, said method comprising:
classifying real estate for sale,
photoing the real estate for sale, and
establishing a data base with the photos of the real estate for sale for searching purposes.

2. The method according to claim 1 further comprising photoing nearby streets around the real estate for sale.

3. The method according to claim 1 further comprising video recording the real estate for sale.

4. The method according to claim 1 further comprising video recording nearby streets around the real estate for sale.

5. The method according to claim 1 further comprising providing quotations and information of the real estate for sale.

6. The method according to claim 1 further comprising mapping an area and nearby streets around the real estate for sale.

7. A method for marketing real estate, said method comprising:
classifying real estate for sale,
tape recording the real estate for sale, and
establishing a data base with the recorded images of the real estate for sale for searching purposes.

8. The method according to claim 7 further comprising photoing the real estate for sale.

9. The method according to claim 7 further comprising photoing nearby streets around the real estate for sale.

10. The method according to claim 7 further comprising video recording nearby streets around the real estate for sale.

11. The method according to claim 7 further comprising providing quotations and information of the real estate for sale.

12. The method according to claim 7 further comprising mapping an area and nearby streets around the real estate for sale.
